(19) United States
(12) Patent Application Publication
(10) Pub. No.: US 2026/0249891 A1
(43) Pub. Date: Aug. 27, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Yuki NAKAGUCHI, Tokyo (JP); Shumpei KUBOSAWA, Tokyo (JP)

(21) Appl. No.: 19/541,559

(22) Filed: Feb. 17, 2026

(30) Foreign Application Priority Data
Feb. 21, 2025 (JP) 2025-026377

(51) Int. Cl. B61L 15/00; G06F 3/0482; G06F 3/0486; G06F 9/451; G06Q 10/109; G06T 7/70

(52) U.S. Cl. CPC B61L 15/0081; G06F 3/0482; G06F 3/0486; G06F 9/451; G06Q 10/1097; G06T 7/70

(57) ABSTRACT

In the information processing device, the setting unit sets, in a coordinate space to which a spatial axis and a temporal axis are set, a plurality of occupied areas including a spatiotemporal occupied area and a temporal occupied area. The the spatiotemporal occupied area indicates a space and a time occupied by movement of a moving object, and the temporal occupied area indicates a time occupied by a time interval of movement of the moving object. The arrangement unit arranges the plurality of occupied areas in the coordinate space in such a way that the spatiotemporal occupied areas do not mutually overlap and the temporal occupied areas do not mutually overlap.

### INCORPORATION BY REFERENCE

This application is based upon and claims the benefit of priority from Japanese Patent Application 2025-026377, filed on February 21, 2025, the disclosure of which is incorporated herein in its entirety by reference.

### TECHNICAL FIELD

The present disclosure relates to an operation plan for moving objects.

### BACKGROUND ART

The transportation of trains, buses, and airplanes is operated and managed in accordance with an operation plan created in advance. JP2023-82606A discloses a system that creates an operation plan using an operation plan creation algorithm.

### SUMMARY

However, the method in JP2023-82606A is complicated in terms of algorithm and is time-consuming for creating an operation plan as a disadvantage.

One object of the present disclosure is to efficiently create an operation plan for moving objects.

According to an example aspect of the present invention, there is provided an information processing device comprising:

a setting means configured to set, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and

an arrangement means configured to arrange the plurality of occupied areas in the coordinate space in such a way that the spatiotemporal occupied areas do not mutually overlap and the temporal occupied areas do not mutually overlap.

According to another example aspect of the present invention, there is provided an information processing method to be performed by a computer, the information processing method comprising:

setting, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and

arranging the plurality of occupied areas in the coordinate space in such a way that the spatiotemporal occupied areas do not mutually overlap and the temporal occupied areas do not mutually overlap.

According to still another example aspect of the present invention, there is provided a program for causing a computer to perform processing comprising:

setting, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and

arranging the plurality of occupied areas in the coordinate space in such a way that the spatiotemporal occupied areas do not mutually overlap and the temporal occupied areas do not mutually overlap.

According to the present disclosure, an operation plan for moving objects can be efficiently created.

### BRIEF DESCRIPTION OF THE DRAWINGS

FIG. 1 illustrates an entire configuration of an operation planning system according to the present disclosure;

FIG. 2 schematically illustrates an example of a train diagram;

FIG. 3 is a block diagram illustrating a hardware configuration of an operation planning device;

FIG. 4 is a block diagram illustrating a functional configuration of the operation planning device;

FIGS. 5A and 5B illustrate states of train diagram creation;

FIGS. 6A and 6B illustrate states of train diagram creation;

FIGS. 7A and 7B illustrate states of train diagram creation;

FIGS. 8A and 8B illustrate states of train diagram creation;

FIGS. 9A and 9B illustrate states of train diagram creation;

FIGS. 10A and 10B illustrate states of train diagram creation;

FIGS. 11A and 11B illustrate examples of time intervals of trains;

FIG. 12 illustrates a time interval at the time of creation of a train diagram;

FIG. 13 illustrates an example of a card;

FIGS. 14A and 14B are explanatory diagrams for a method of arranging cards;

FIGS. 15A to 15C are explanatory diagrams for a method of arranging cards;

FIG. 16 is a flowchart of train diagram creation processing;

FIG. 17 is a block diagram illustrating the configuration of an information processing device according to the present disclosure; and

FIG. 18 is a flowchart of processing that the information processing device performs.

### EXAMPLE EMBODIMENTS

Preferred example embodiments of the present disclosure will be described below with reference to the drawings.

### First Example Embodiment

### Entire Configuration

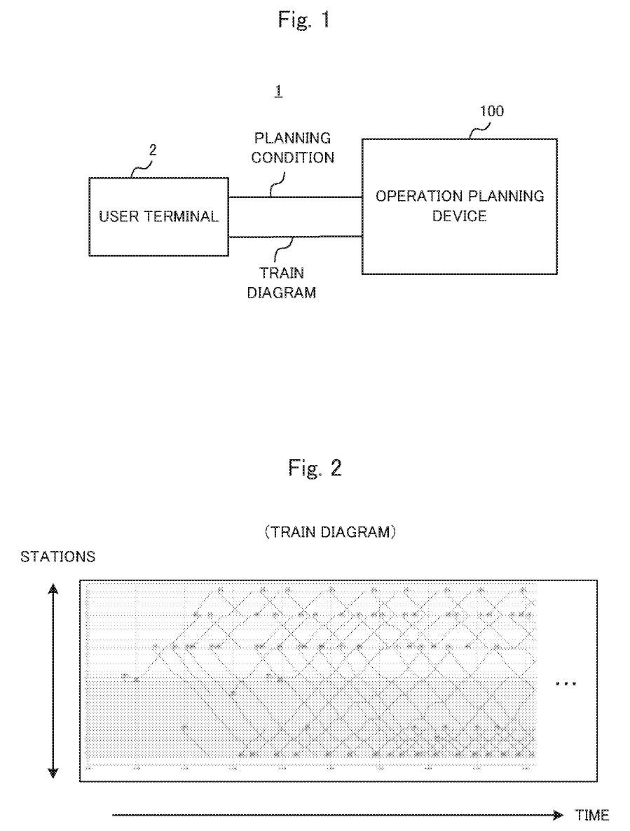

FIG. 1 illustrates the entire configuration of an operation planning system according to a first example embodiment. The operation planning system 1 is a system that creates a diagram for moving objects, and includes a user terminal 2 and an operation planning device 100. The operation planning device 100 is an example of an information processing device according to the present disclosure, and creates a diagram for moving objects. In the present example embodiment, moving objects are trains and the operation planning device 100 creates a train operation plan (hereinafter, also referred to as a “train diagram”). In particular, the operation planning device 100 creates a train diagram in such a way as to prevent a train overlap from occurring in a section that a train may occupy in space and time, such as a single-track section.

The operation planning device 100 may be a server device, for example. The user terminal 2 corresponds to a terminal device, such as a personal computer, used by a user who creates an operation plan, such as a planner in a railway company. The user terminal 2 and the operation planning device 100 are connected communicably through a network, for example.

The user transmits a planning condition regarding a train diagram to be created to the operation planning device 100 by the user terminal 2. The operation planning device 100 creates a train diagram based on the planning condition transmitted from the user terminal 2 and route information prepared in advance, and then outputs the train diagram to the user terminal 2. The “train diagram” indicates a train operation plan or operation status in a diagram and is also referred to as an operation diagram or a diagram. FIG. 2 schematically illustrates an example of a train diagram. The train diagram corresponds to a graph in which the horizontal axis represents time and the vertical axis represents stations. Each zigzag line in the graph corresponds to a train, and indicates a train operation in which the train departs from a certain station at a certain time, arrives at a certain station at a certain time, and keeps stopped at a certain station during a certain time (minutes).

### Hardware Configuration

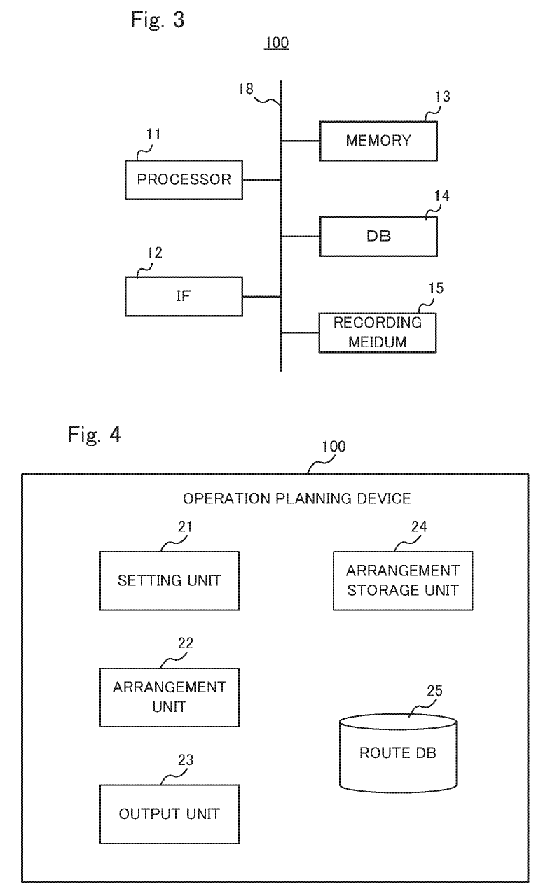

FIG. 3 is a block diagram illustrating a hardware configuration of the operation planning device 100. As illustrated, the operation planning device 100 includes a processor 11, an interface (IF) 12, a memory 13, a database (DB) 14, and a recording medium 15. Such elements are connected together through a bus 18.

The processor 11 may be a computer, such as a central processing unit (CPU), and executes a program prepared in advance to control the entire operation planning device 100. Note that, as the processor 11, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or any combination thereof can be used. The processor 11 performs train diagram creation processing, which will be described later.

The IF 12 receives, for example, a creation instruction and a planning condition for a train diagram from the user terminal 2. The IF 12 outputs the train diagram created by the operation planning device 100 to the user terminal 2.

The memory 13 includes, for example, a read only memory (ROM) and a random access memory (RAM). The memory 13 stores various types of programs that the processor 11 executes. In addition, the memory 13 is used as a working memory while the processor 11 is performing various types of processing.

The DB 14 stores various types of data necessary for creating a train diagram. For example, the DB 14 stores train route information and train (vehicle) information used by the railway company.

The recording medium 15 corresponds to a non-volatile and non-transitory recording medium, such as a disk-shaped recording medium or a semiconductor memory, and is detachably attached to the operation planning device 100. The recording medium 15 has various types of programs recorded thereon and executed by the processor 11. In a case where the operation planning device 100 performs various types of processing, a program recorded on the recording medium 15 is loaded into the memory 13 and executed by the processor 11.

### Functional Configuration

FIG. 4 is a block diagram illustrating a functional configuration of the operation planning device 100. As illustrated in FIG. 4, the operation planning device 100 includes a setting unit 21, an arrangement unit 22, an output unit 23, an arrangement storage unit 24, and a route DB 25.

The route DB 25 stores train route information. The train route information includes, for example, railway track network information, station information, and vehicle base information. The route DB 25 is configured by the DB 14 illustrated in FIG. 3.

Initially, the setting unit 21 acquires setting information for creating a train diagram from the route DB 25. The setting information includes, for example, information on a position to which a train travels and a section in which a train travels, such as a station and the distance between stations, and information on a target period of time over which a train diagram to be created ranges. Note that a section in which a train travels corresponds to an occupied section, such as a single-track section. Meanwhile, such a single-track section corresponds to an inter-station section, and a station corresponds to a double-track section, namely, an unoccupied section.

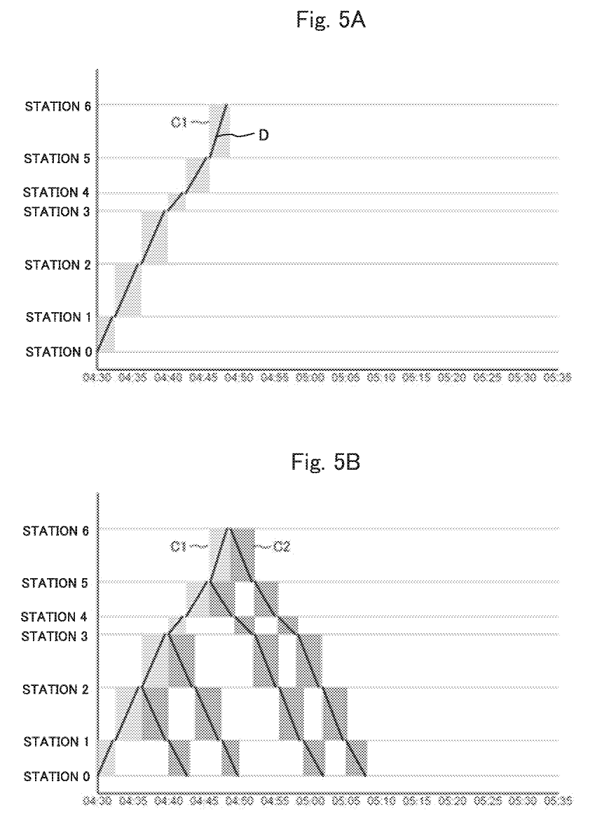

The setting unit 21 prepares for creating a train diagram, based on the acquired setting information. Specifically, as illustrated in FIG. 5A, for example, the setting unit 21 creates a coordinate space for a train diagram that has a horizontal axis to which time (time of day) is set and a vertical axis to which stations (positions) are set. That is, the coordinate space for a train diagram has a temporal axis as the horizontal axis and a spatial axis as the vertical axis. In addition, the setting unit 21 sets a card corresponding to a train that travels in an inter-station section to the coordinate space for a train diagram. The card corresponds to a rectangular figure indicating the position and time planned for the movement of the train, namely, a spatiotemporal figure, and includes a train path that is indicated by a diagonal line in the rectangular figure and corresponds to the movement of the train. As an example, as illustrated in FIG. 5A, the card can be arranged in each inter-station section and is formed to have its horizontal width indicating the time of the movement and its vertical width indicating an inter-station section. A train path (time-space path) D indicated by a diagonal line of a card is formed extending from the coordinates of a departure point (departure time, departure station) to the coordinates of an arrival point (arrival time, arrival station). The vertical width of the card corresponds to the inter-station section as serving a single-track section in which the train travels, and the horizontal width thereof corresponds to the time during which the train travels in the inter-station section. Thus, the area of the card indicates an area in which the corresponding train occupies an inter-station section as a single-track section, namely, an occupied area in the coordinate space. That is, other train is not allowed to enter the real space ranging over a period of time corresponding to the area in which the card is arranged in the coordinate space.

The arrangement unit 22 arranges cards corresponding to trains in the coordinate space for a train diagram. Specifically, as illustrated in FIG. 5A, the arrangement unit 22 first arranges cards C1 corresponding to the first train. In this case, the arrangement unit 22 arranges one card C1 in each inter-station section. FIG. 5A illustrates the status of arrangement of the cards C1 for a train that departs from “STATION 0” at the time “04:30” and arrives at “STATION 6” at the time “04:48”.

Subsequently, as illustrated in FIG. 5B, the arrangement unit 22 arranges cards C2 corresponding to different trains that cross the first train at the stations. Specifically, the arrangement unit 22 arranges the cards C2 in such a way that the different trains depart in the opposite direction from the stations which the first train departs/arrives from/at at a time at which the first train departs/arrives. Note that the inter-card part between each card C1 for the first train, namely, the part between vertices of the adjacent cards C1 is located at a departure/arrival station and thus is located in an unoccupied area based on the first train because the station corresponds to a double-track section. Thus, in a case where the first train keeps stopped in an inter-card part, namely, at a station, a different train can stop at the station and thus the trains can mutually cross to depart in the opposite directions. In order to arrange the cards C2 for the different trains, the arrangement unit 22 selects a plurality of stations in a balanced manner from the stations which the first train departs/arrives from/at, and then arranges the cards C2 in such a way that the different trains depart one-to-one from the selected plurality of stations. As described above, the arrangement unit 22 arranges the cards C2 corresponding to the different trains that cross the first train at the stations in a leveled manner in the coordinate space for a train diagram. FIG. 5B illustrates a status where the cards C2 are arranged for the different trains each departs in the opposite direction from “STATION 2”, “STATION 3”, “STATION 5”, and “STATION 6” at the time at which the first train departs/arrives. The arrangement unit 22 arranges the cards C2 for each of four different trains.

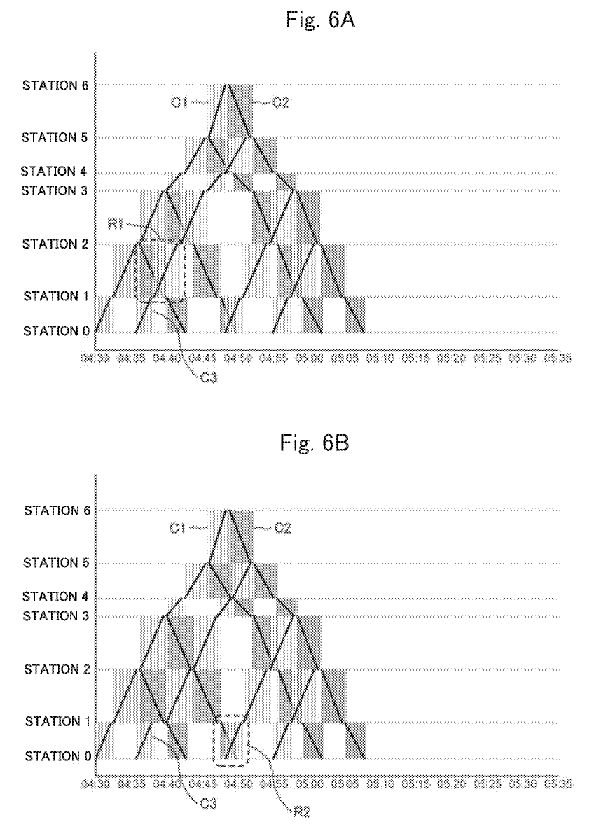

Subsequently, as illustrated in FIG. 6A, the arrangement unit 22 further arranges the cards C3 corresponding to another train, based on the status of the movement of the first train corresponding to the cards C1 and the different trains corresponding to the cards C2, namely, based on the arrangement of the cards C1 for the first train and the cards C2 for the different trains. For example, the arrangement unit 22 arranges the cards C3 corresponding to the another train in such a way that the another trains departs, in the direction in which the first train travels, at a predetermined time from the time at which the first train departs. In this case, the arrangement unit 22 further arranges the cards C3 in such a way that the another train crosses at the station which the different trains corresponding to the cards C2 departs/arrives from/at at a time which the different trains corresponding to the cards C2 departs/arrives. The arrangement unit 22 further arranges the cards C3 corresponding to a still another train similar to the above-described other train with a predetermined time provided. For example, the arrangement unit 22 arranges cards C3 for a plurality of other trains in a patterned manner in such a way that each of the plurality of other trains departs/arrives from/at each station with a constant interval with the first train or regularly in terms of time. FIG. 6A illustrates a status where the cards C3 are arranged for the another train that departs from “STATION 0” at the time “04:36” and crosses the different train corresponding to the cards C2 at “STATION 5” at the time “04:52”, the cards C3 are arranged for still another train that departs from “STATION 0” at the time “04:48” and crosses the different train corresponding to the cards C2 at “STATION 3” at the time “04:57”, and the cards C3 are arranged for still another train that departs from “STATION 0” at the time “04:55” and crosses the different train corresponding to the cards C2 at “STATION 2” at the time “05:02”. The arrangement unit 22 arranges the cards C3 for each of three other trains. Note that the cards for the other trains are arranged only in some sections on the departure station side.

Subsequently, after the arrangement of the cards C3 for the other trains as described above, in a case where the card C3 for any of the other trains overlaps any of the cards C1 and C2 for the different trains, the arrangement unit 22 moves the card in the coordinate space in such a way as to resolve the overlap between the cards. In a case where the card overlap occurs at a plurality of places, the arrangement unit 22 moves the cards in chronological order of overlap in such a way as to resolve the card overlaps. Furthermore, in this case, the arrangement unit 22 moves one of the overlapping cards in the direction of an increase in time to resolve the overlap. Note that the arrangement unit 22 may shorten the horizontal width of the card, instead of moving the card. Since the horizontal width of the card corresponds to the time during which a train moves in an inter-station section, and the arrangement unit 22 may change the speed of the train within the speed limit to change the time of movement in the inter-station section. As described above, the arrangement unit 22 moves the arrangement of one of overlapping cards or changes the horizontal width of the card to set the cards in the coordinate space in such a way that the card overlap is resolved.

In the example of FIG. 6A, the card overlap occurs at a plurality of places. That is, the card C3 for the train that departs from “STATION 0” at the time “04:36” overlaps the card C2 for the different train at the place R1. The place is earliest in time among the plurality of places each having the card overlap occurring, and thus the arrangement unit 22 shifts the card C3 for the train to a later time to resolve the card overlap. Along with this, the arrangement unit 22 shifts the other cards C3 corresponding to the same train to later times in a chain manner. If any card overlap occurs due to the shift, the overlap is resolved in such a similar manner as described above. As a result, as illustrated in FIG. 6B, the overlap of the card C3 at the place R1 for the train that departs from “STATION 0” at the time “04:36” is resolved.

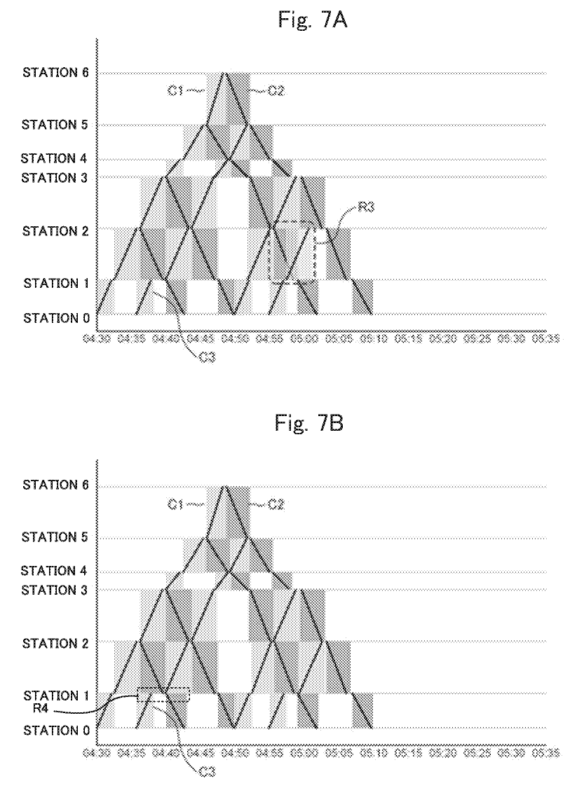

Subsequently, referring to FIG. 6B, the card overlap occurs at the place R2 at a further later time, and thus the arrangement unit 22 moves the cards for the train corresponding to the card to later times in such a similar manner as described above to resolve the card overlap as illustrated in FIG. 7A. Subsequently, referring to FIG. 7A, the card overlap occurs at the place R3 at a further later time, and thus the arrangement unit 22 moves the cards for the train corresponding to the card to later times in such a similar manner as described above to resolve the card overlap as illustrated in FIG. 7B.

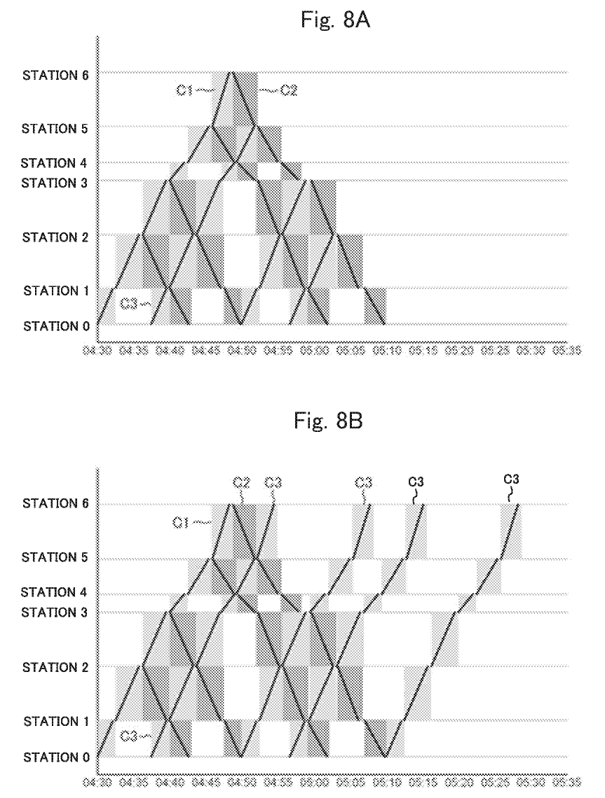

Note that, at the time of resolution of the card overlaps described above, the arrangement unit 22 may move cards as appropriate in order to resolve an unnecessary time in the stopping time at each station of each train. For example, referring to FIG. 7B, regarding the train that departs from “STATION 0” at the time “04:36”, an unnecessary time is generated in the stopping time at the next “STATION 1” as indicated by the dotted rectangle R4. Thus, the arrangement unit 22 moves the corresponding card C3, as illustrated in FIG. 8A, in such a way as to shorten the stopping time at “STATION 1” of the train. Note that, in the above-described example, the cards are set to move in such a way that any card overlap is resolved, but the horizontal widths of the cards may be changed in such a way that any card overlap is resolved.

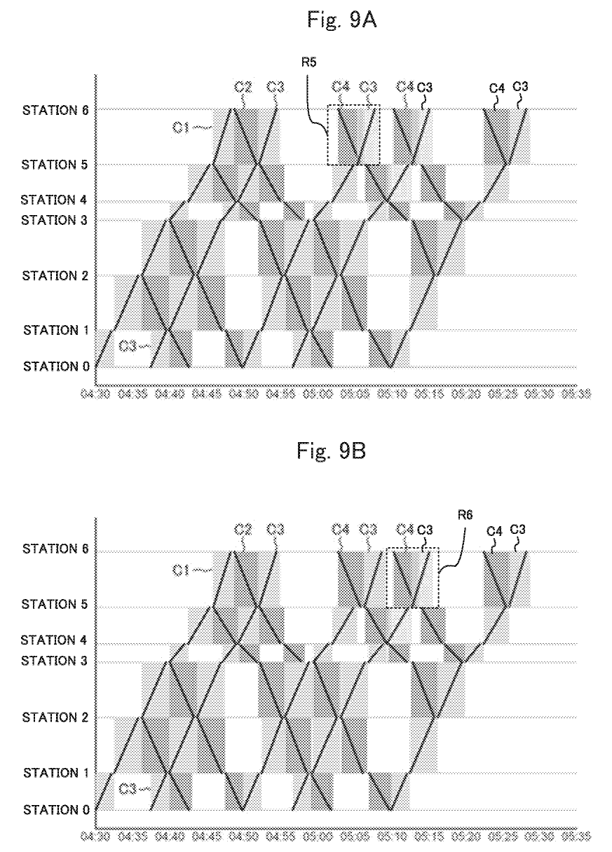

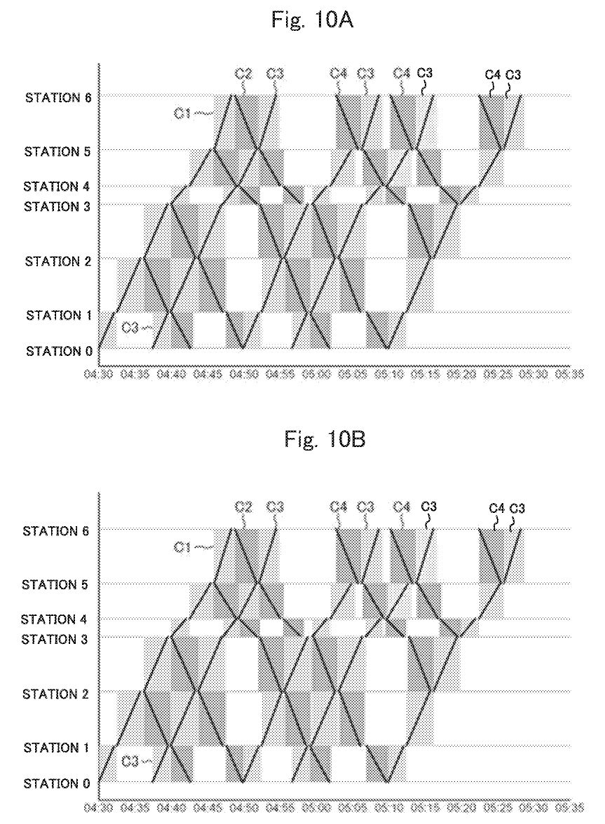

Subsequently, since the train diagram has not been completed yet and the card arrangement has not been finished yet, the arrangement unit 22 further arranges the cards C3 for the other trains for the following sections. For example, as illustrated in FIG. 8B, the cards C3 for the other trains are additionally arranged for the following sections at cross places with the cards C2 for the different trains. Then, similarly to the cards C2 for the different trains described above, as illustrated in FIG. 9A, the arrangement unit 22 further arranges the cards C4 corresponding to the different trains each crosses another train at a station. In this case, if the card overlaps occur due to the arrangement of the cards C4, the arrangement unit 22 moves the cards in chronological order to later times in a similar manner as described above to resolve the overlaps. For example, the arrangement unit 22 resolves the overlap at the place R5 in the status illustrated in FIG. 9A to obtain the status in FIG. 9B, and further resolves the overlap at the place R6 in FIG. 9B to obtain the status in FIG. 10A. Then, if an unnecessary time is generated in the stopping time at each station of each train due to the resolution of the overlaps, as illustrated in FIG. 10B, the arrangement unit 22 moves the corresponding card in such a way as to shorten the stopping time.

Furthermore, the arrangement unit 22 matches the arrangement shape of the cards corresponding to the first train with the arrangement shape of the cards corresponding to the last train so that a resultant diagram can be repeatedly used as a part of the train diagram. In the above example, the arrangement shape of the cards C3 corresponding to the last train is matched with the arrangement shape of the cards C1 corresponding to the first train. Thus, by using the train diagram illustrated in FIG. 10B as one block and such a block is added in such a way as to match the arrangement shape of the cards C1 for the first train with the arrangement shape of the cards C3 for the last train in the previous block, a train diagram ranging over a longer time can be created. Note that, after arranging the cards or moving the cards as described above, the arrangement unit 22 always stores the arrangement of the cards in the coordinate space for the train diagram into the arrangement storage unit 24.

Then, when a desired train diagram is completed and the card arrangement is finished, the output unit 23 creates the train diagram, based on the arrangement of the cards in the final train diagram, and outputs the train diagram. Note that the output unit 23 may extract the departure/arrival time at each station of each train from the arrangement of the cards and the train path in each card to create and output data for a train timetable.

### Configuration of Card

By the above method, a train diagram can be created with no train overlap in a section that a train may occupy in space and time, such as a single-track section. However, in practice, a certain operation interval is required to be ensured between trains for safety. Such an operation interval for trains includes a distance interval and a time interval. The distance interval can be ensured by arranging the card with no overlap by the above method. If the distance interval is ensured, basically, a certain degree of time interval is ensured. However, sometimes the time interval may be required to be ensured more directly.

The time interval is determined, for example, in comprehensive consideration of the stopping time of a train at a station, the passenger handling capacity of a station, the performance of acceleration/deceleration, operating speed, and length of a train, and the function of a signal. For example, in a case where the next train arrives at a narrow station with alighting passengers having not left the station yet, it can be thought that alighting passengers fill the station. Thus, in the present example embodiment, the shape of a card is devised in such a way that a train diagram is created with a time interval ensured between trains.

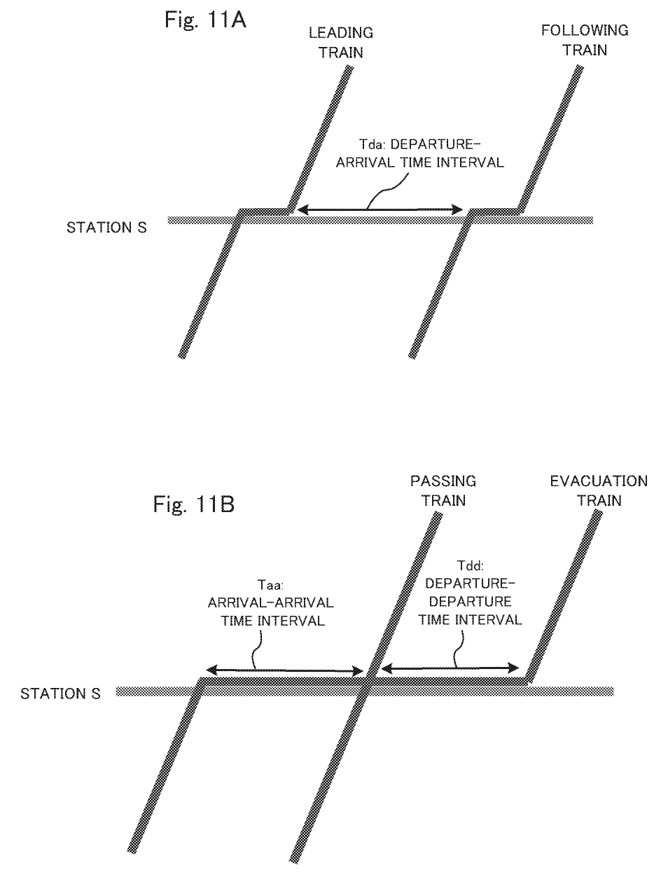

FIGS. 11A and 11B illustrate examples of time interval of trains. FIG. 11A illustrates a time interval between consecutive trains. FIG. 11A is part of a train diagram and illustrates the movements of the leading train and the following train at a certain station S. The time interval from the departure of the leading train from the station S to the arrival of the following train at the station S is referred to as a departure-arrival time interval Tda. As described above, in order to prevent a station from being filled with alighting passengers, the departure-arrival time interval Tda meeting the passenger handling capacity of the station is required to be ensured.

FIG. 11B illustrates time intervals in a case where a train waits for a passing train. The time interval from the arrival of the train that waits for a passing train (referred to as an “evacuation train”) to the station S to the passing of the passing train through the station S (namely, the arrival of the passing train at the station S) is referred to as an arrival-arrival time interval Taa. The time interval from the passing of the passing train through the station S (namely, the departure of the passing train from the station S) to the departure of the evacuation train from the station S is referred to as a departure-departure time interval Tdd. For safe passing, a proper arrival-arrival time interval Taa and a proper departure-departure time interval Tdd are required to be ensured.

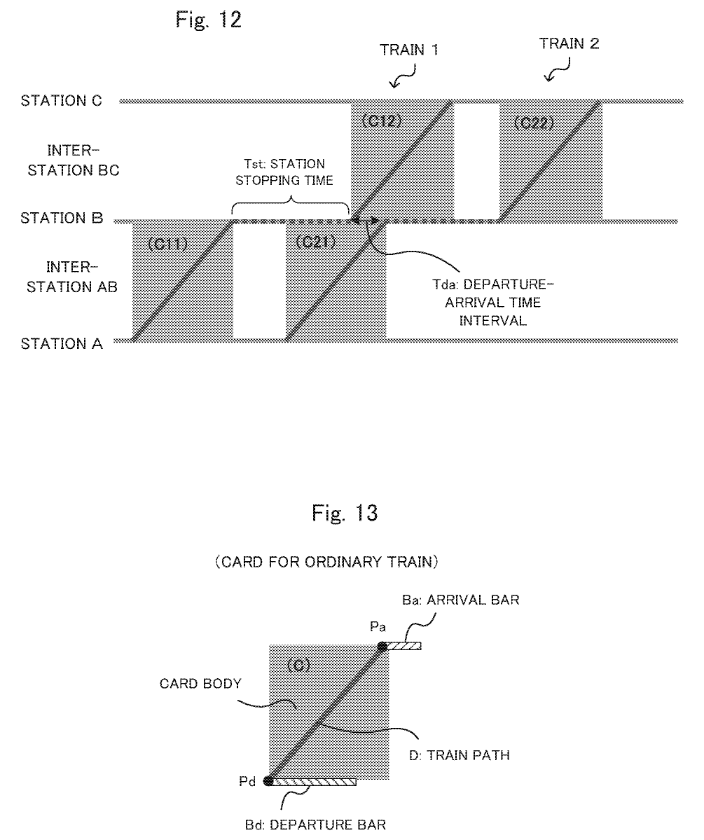

FIG. 12 illustrates a time interval at the time of creation of a train diagram by the above-described method. As illustrated in FIG. 12, a train 1 serving as the leading train and a train 2 serving as the following train sequentially stop at stations A to C in this order. In this case, according to the above-described method, the arrangement unit 22 arranges a card C11 for the train 1 in an inter-station section AB and arranges a card C12 for the train 1 in an inter-station section BC. The stopping time of the train 1 at the station B is indicated by a station stopping time Tst. Also, the arrangement unit 22 arranges a card C21 for the train 2 in the inter-station section AB and arranges a card C22 for the train 2 in the inter-station section BC.

In this case, the departure-arrival time interval Tda at the station B, namely, the time interval from the departure of the train 1 from the station B to the arrival of the train 2 at the station B is defined by the distance between the lower left vertex (corner) of the card C12 and the upper right vertex (corner) of the card C21 as indicated with a double-headed arrow. According to the above-described method, the arrangement unit 22 arranges each card in such a way that cards adjacent in the direction of the temporal axis in each individual inter-station section do not overlap, but card interference between adjacent inter-station sections is not taken into account. Thus, the arrangement unit 22 may arrange each card, like the cards C21 and C12 in FIG. 12. In this case, the departure-arrival time interval Tda at the station B is insufficient.

Thus, in the present example embodiment, cards to be arranged in the coordinate space for a train diagram are provided with a bar corresponding to a time interval (hereinafter, also referred to as a “time interval bar”), and the arrangement unit 22 arranges each card with interference between time interval bars taken into account. FIG. 13 illustrates an example of a card C having time interval bars. Note that FIG. 13 illustrates an example of a card for an ordinary train other than a passing train and an evacuation train, which will be described later. A train path D connecting the departure point Pd and arrival point Pa of a train is set to the card C. Note that a rectangular portion having the train path D of the card C as a diagonal line is referred to as a “card body”. In a case where a card is regarded as an area that occupies the coordinate space for a train diagram, its card body is a “spatiotemporal occupied area“ serving as an area indicating the space and time occupied due to movement of the train.

Furthermore, the card C is provided with, as an example of a time interval bar, a departure bar Bd extending from the departure point Pd in the direction of the temporal axis. The length of the departure bar Bd defines the departure-arrival time interval Tda with the following train. That is, by setting the length of the departure bar Bd to a necessary length, a necessary departure-arrival time interval Tda with the following train can be ensured. The time interval bar is an example of a “temporal occupied area” serving as an area indicating the time occupied due to the time interval of movement of a moving object. The entire card in which the card body is provided with the time interval bar is an example of an “occupied area”.

Furthermore, the card C is provided with, as another example of a time interval bar, an arrival bar Ba extending from the arrival point Pa in the direction of the temporal axis. The left end of the arrival bar Ba, namely, the position of the arrival point Pa defines the arrival time of the train corresponding to the card C. Therefore, the card C is arranged in such a way that the left end of its arrival bar Ba does not overlap the departure bar Bd of another card C arranged in the adjacent inter-station section, so that the departure-arrival time interval Tda based on the length of the departure bar Bd can be ensured. The departure bar Bd is an example of a “departure-arrival time area”.

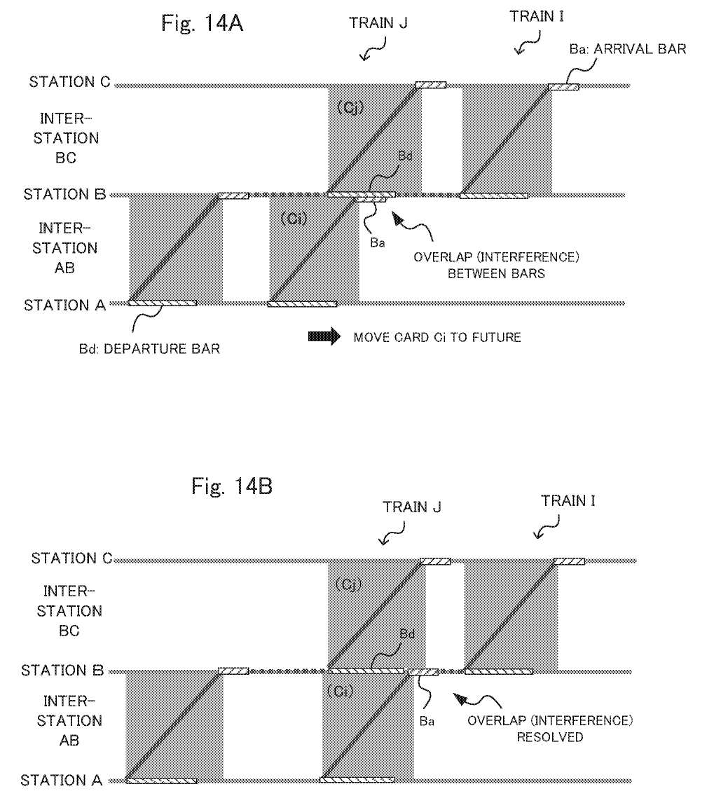

FIGS. 14A and 14B are explanatory diagrams for a method of arranging the cards with the time interval bars taken into account. FIG. 14A illustrates a state where the cards are arranged in inter-station sections by the above-described card arrangement method. According to the above-described card arrangement method, no interference between the arranged cards between adjacent inter-station sections is taken into account, and thus the arrival bar Ba of a card Ci for a train I and the departure bar Bd of a card Cj for a train J overlap, causing interference between time interval bars.

Thus, the arrangement unit 22 moves the card Ci in the future direction of the temporal axis. FIG. 14B illustrates a state after the card Ci is moved. The arrangement unit 22 moves the card Ci in the future direction until the overlap between the arrival bar Ba of the card Ci and the departure bar Bd of the card Cj is resolved. Thus, the departure-arrive time interval Tda from the departure of the train J from the station B to the arrival of the following train I at the station B can be made equal to or more than the time corresponding to the length of the departure bar Bd. As described above, by providing a card C with the time interval bar of a proper length, a time interval necessary for the actual operation of trains can be ensured in a train diagram.

Note that, as described above, the arrival bar Ba is used for determining an overlap with the departure bar Bd and thus may be a bar having a temporal width of 0, namely, a point. That is, instead of the arrival bar, an arrival point may be provided to a card.

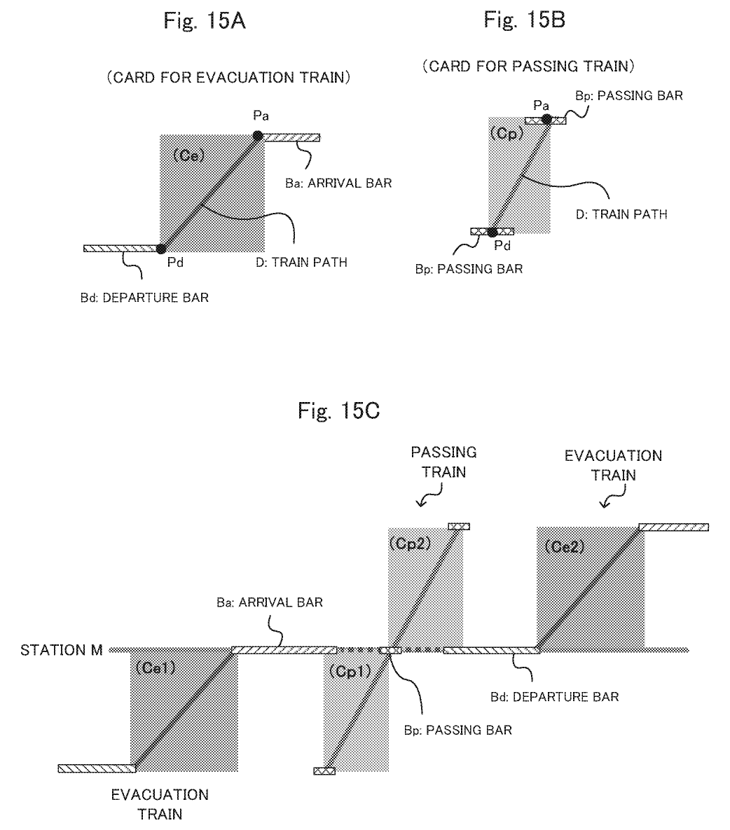

Next, an example in which a train waits for a passing train will be described. FIG. 15A illustrates an example of a card Ce for an evacuation train. The card Ce for an evacuation train waiting for a passing train is provided with a departure bar Bd and an arrival bar Ba, in addition to a train path D. Note that, in comparison to that in FIG. 13, the departure bar Bd of the card Ce for an evacuation train extends from the departure point Pd of the train path in the past direction of the temporal axis. FIG. 15B illustrates an example of a card Cp for a passing train. The card Cp for a passing train is provided with a train path D, a passing bar Bp extending from the departure point Pd of the train path in the past and future direction of the temporal axis, and another passing bar Bp extending from the arrival point Pa of the train path in the past and future directions of the temporal axis. The passing bars Bp serve as a bar having the functions of an arrival bar and a departure bar. Note that such a passing bar Bp may be a bar having a temporal width of 0, namely, a point in a case where the passing time is regarded as zero with the length of the train not taken into account. Such a passing bar Bp is an example of a “passing time area”.

FIG. 15C illustrates an example in which cards are arranged for a train that waits for a passing train with time interval bars taken into account. As illustrated, in order to ensure the arrival-arrival time interval Taa between the arrival of an evacuation train and the arrival of a passing train, preferably, the arrangement unit 22 arranges a card Ce1 for the evacuation train and a card Cp1 for the passing train in such a way that the arrival bar Ba of the evacuation train and a passing bar Bp of the passing train do not overlap. In order to ensure the departure-departure time interval Tdd between the passing of the passing train and the departure of the evacuation train, preferably, the arrangement unit 22 arranges a card Cp2 for the passing train and a card Ce2 for the evacuation train in such a way that a passing bar Bp of the passing train and the departure bar Bd of the evacuation train do not overlap. Thus, even in a case where a train waits for a passing train, a time interval necessary for the actual operation of trains can be ensured.

### Train Diagram Creation Processing

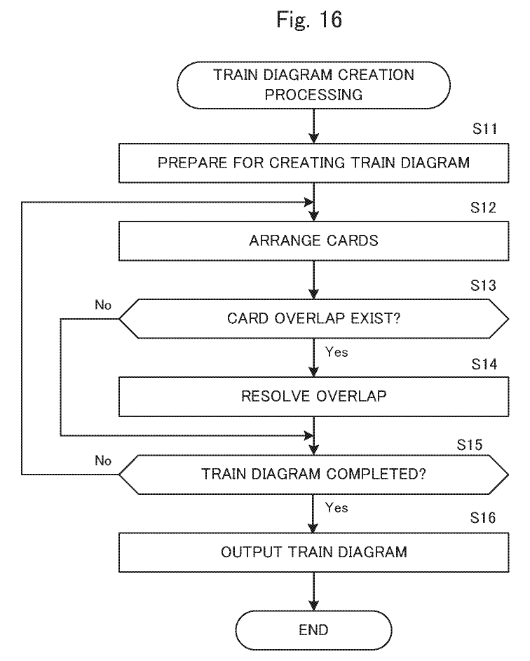

Next, train diagram creation processing will be described. FIG. 16 is a flowchart of the train diagram creation processing. For achievement of the processing, the processor 11 illustrated in FIG. 3 executes the program prepared in advance to operate as each element illustrated in FIG. 4.

First, the setting unit 21 acquires setting information for creating a train diagram and prepares for creating a train diagram (step S11). Specifically, the setting unit 21 creates such a coordinate space for a train diagram as illustrated in FIG. 5A. The setting unit 21 sets cards each corresponding to a train that travels in an inter-station section and each arranged in the coordinate space for a train diagram. The cards correspond to the cards exemplified in FIGS. 13, 15A, and 15B.

Next, as described with reference to FIGS. 5A to 10B, the arrangement unit 22 arranges cards in the coordinate space for a train diagram (step S12). Next, the arrangement unit 22 determines whether an overlap (interference) has occurred between arranged cards (step S13). In this case, the arrangement unit 22 determines whether or not an overlap exists between the card main bodies of adjacent cards and determines whether or not an overlap exists between the time interval bars thereof. Then, in a case where no overlap exists between the card main bodies and no overlap exists between the time interval bars, the arrangement unit 22 determines that no overlap exists between the cards. In a case where no overlap exists between the cards (step S13: No), the processing proceeds to step S15.

On the other hand, in a case where an overlap exists between the cards (step S13: Yes), the arrangement unit 22 moves one of the overlapping cards as described above to resolve the card overlap. Note that, in a case where an overlap exists between the card main bodies, the arrangement unit 22 may change the horizontal width of one of the card main bodies to resolve the overlap.

As above, the arrangement unit 22 repeats steps S13 and S14 until no card overlap exists. Then, in a case where no card overlap exists (step S13: No), the arrangement unit 22 determines whether a train diagram corresponding to a period of time to be created has been completed due to the completion of arrangement of necessary cards (step S15). In a case where a train diagram has not been completed yet (step S15: No), the processing goes back to step S12, and then the arrangement unit 22 further arranges cards. On the other hand, in a case where a train diagram has been completed (step S15: Yes), the output unit 23 outputs the final train diagram (step S16). Note that the output unit 23 may store the final train diagram into the arrangement storage unit 24. Thus, the train diagram creation processing ends.

Note that the output unit 23 may create and output a train timetable, based on the arrangement of the cards in the final train diagram. For example, the output unit 23 may extract the departure/arrival time at each station of each train from the arrangement of the cards and the train path in each card to create and output data for a train timetable.

### Modifications

### First Modification

The example embodiment described above can be also applied to a case where a train operates in a turn-back service. For example, after a train A turns back at a station X, a train B turns back at the same station X. In this case, a card Ca for the train A that departs from the station X by turning back is provided with a departure bar Bca extending from a departure point in the future direction. In addition, a card Cb for the train B that arrives at the station X is provided with an arrival bar Bcb extending from an arrival point in the future direction. Then, the cards Ca and Cb are arranged in such a way that the card main bodies of the cards Ca and Cb do not overlap and the departure bar Bca and the arrival bar Bcb do not overlap, so that a time interval can be ensured between the train A and the train B in turn-back operation.

### Second Modification

In the example embodiment described above, a station is provided as a target place at which a time interval is required, but a place at which a time interval is required is not limited to a station. In general, a place at which a time interval is required for moving objects for which a movement schedule is created corresponds to a place to which arrival/departure time (arrival time or departure time) is set in the movement schedule. For railways, examples of a place at which a time interval is required include a station and a signal station. Such a signal station indicates a stop with no passenger boarding or alighting, and there are a large number of types of signal stations. Examples of signal stations are as follows:

A place for train exchange (crossing) in a single-track section

A place for train overtaking in a double-track section

A railway junction

The boundary between a single-track section and a double-track section and the boundary between a double-track section and a quadruple-track section

The boundary between block sections that are not of an automatic block type in a single-track section

A place for trains to turn back and a train storage yard

A place provided with a switch-back structure for reversing a travel direction due to steep terrain

Therefore, for railways, preferably, target places for signal stations are set, similarly to stations, in the coordinate space for a train diagram, and a card is arranged in the section between a target place and a station adjacent thereto.

### Third Modification

In the example embodiment described above, since moving objects are trains, a train diagram is created. However, the present disclosure is not limited to a case where moving objects as targets for which a diagram is created are trains, and thus can be applied to a case where a diagram is created for any type of moving object, such as an airplane, a ship, a satellite, or a drone. For example, the present disclosure can be also applied to a case where moving objects are airplane, a spatiotemporal occupied area corresponds to a predetermined area during a predetermined time over an airport or a runway, and a diagram is created in such a way that an airplane overlap does not occur in the spatiotemporal occupied area.

### Second Example Embodiment

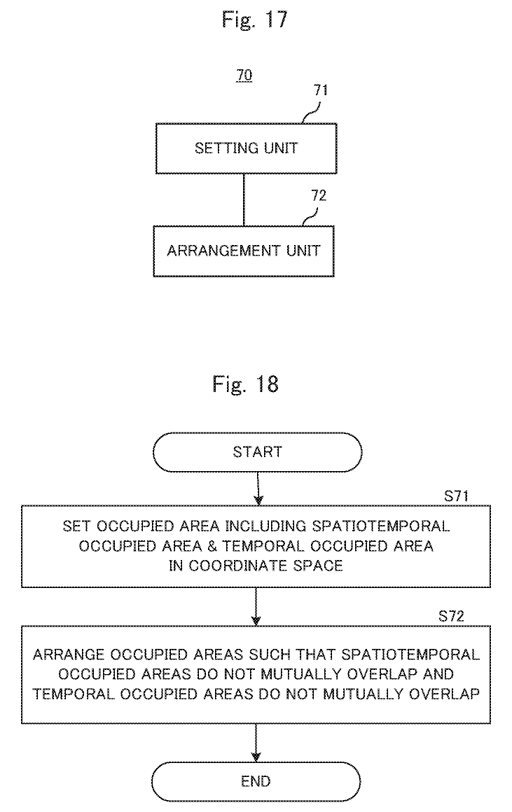

FIG. 17 is a block diagram illustrating a functional configuration of an information processing device according to a second example embodiment. An information processing device 70 includes a setting unit 71 and an arrangement unit 72.

FIG. 18 is a flowchart of processing that the information processing device according to the second example embodiment performs. The setting unit 71 sets, in a coordinate space to which a spatial axis and a temporal axis are set, a plurality of occupied areas including a spatiotemporal occupied area and a temporal occupied area (step S71). The the spatiotemporal occupied area indicates a space and a time occupied by movement of a moving object, and the temporal occupied area indicates a time occupied by a time interval of movement of the moving object. The arrangement unit 72 arranges the plurality of occupied areas in the coordinate space in such a way that the spatiotemporal occupied areas do not mutually overlap and the temporal occupied areas do not mutually overlap (step S72).

The information processing device 70 according to the second example embodiment enables efficient creation of an operation plan for moving objects.

Some or all of the example embodiments described above may also be described as, but are not limited to, the following Supplementary Notes.

### Supplementary note 1

An information processing device comprising:

a setting means configured to set, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and

an arrangement means configured to arrange the plurality of occupied areas in the coordinate space in such a way that the spatiotemporal occupied areas do not mutually overlap and the temporal occupied areas do not mutually overlap.

### Supplementary note 2

The information processing device according to Supplementary note 1, wherein the temporal occupied area includes a departure-arrival time area corresponding to a time interval required between a departure time of a leading moving object and an arrival time of a following moving object at a target place at which a time interval is required.

### Supplementary note 3

The information processing device according to Supplementary note 1 or 2, wherein the temporal occupied area includes a passing time area corresponding to a time interval required for one moving object to pass a target place at which a time interval is required, with another moving object keeping stopped at the target place.

### Supplementary note 4

The information processing device according to any one of Supplementary notes 1 to 3, wherein the arrangement means arranges, in the coordinate space, one of overlapping occupied areas for which the spatiotemporal occupied areas or the temporal occupied area mutually overlap, in such a way that overlap is resolved.

### Supplementary note 5

The information processing device according to Supplementary note 4, wherein the arrangement means arranges the one of the overlapping occupied areas, in chronological order of overlap, in the coordinate space in such a way that the other one of the overlapping occupied area does not overlap the one of the overlapping occupied area.

### Supplementary note 6

The information processing device according to Supplementary note 5, wherein the arrangement means arranges the one of the overlapping occupied areas at a later time in the coordinate space in such a way that the other one of the overlapping occupied area does not overlap the one of the overlapping occupied areas.

### Supplementary note 7

The information processing device according to any one of Supplementary notes 1 to 6, wherein the arrangement means arranges an occupied area for a second moving object in the coordinate space in such a way that the second moving object crosses a first moving object at a position and a time of an occupied area for the first moving object in the coordinate space.

### Supplementary note 8

The information processing device according to Supplementary note 7, wherein the arrangement means arranges occupied areas for a plurality of the second moving objects in a leveled manner in the coordinate space in such a way that the plurality of the second moving objects crosses the first moving object at a plurality of positions and times corresponding to a plurality of occupied areas for the first moving object in the coordinate space.

### Supplementary note 9

An information processing method to be performed by a computer, the information processing method comprising:

setting, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and

arranging the plurality of occupied areas in the coordinate space in such a way that the spatiotemporal occupied areas do not mutually overlap and the temporal occupied areas do not mutually overlap.

### Supplementary note 10

A program for causing a computer to perform processing comprising:

setting, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and

arranging the plurality of occupied areas in the coordinate space in such a way that the spatiotemporal occupied areas do not mutually overlap and the temporal occupied areas do not mutually overlap.

Some or all of the configurations described in Supplementary Notes 2 to 8 dependent on the above-described Supplementary Note 1 may also be dependent on Supplementary Notes 9 and 10 due to a dependency relationship similar to that of Supplementary Notes 2 to 8. Furthermore, some or all of the configurations described as Supplementary Notes may be dependent on not only Supplementary Notes 1, 9, and 10, but also various types of hardware and software, various recording means for recording software, and systems without departing from the above-described example embodiments.

While the present disclosure has been described above with reference to example embodiments and examples, the present disclosure is not limited to the example embodiments and examples. Various modifications understandable by those skilled in the art can be made to the configurations or details in the present disclosure without departing from the scope of the present disclosure.

### DESCRIPTION OF SYMBOLS

1 Operation planning system

11 Processor

21 Setting unit

22 Arrangement unit

23 Output unit

24 Arrangement storage unit

25 Route DB

100 Operation planning device

1. An information processing device comprising:
a memory configured to store instructions; and
a processor configured to execute the instructions to:
set, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and
arrange the plurality of occupied areas in the coordinate space in such a way that the spatiotemporal occupied areas do not mutually overlap and the temporal occupied areas do not mutually overlap.

2. The information processing device according to claim 1, wherein the temporal occupied area includes a departure-arrival time area corresponding to a time interval required between a departure time of a leading moving object and an arrival time of a following moving object at a target place at which a time interval is required.

3. The information processing device according to claim 1, wherein the temporal occupied area includes a passing time area corresponding to a time interval required for one moving object to pass a target place at which a time interval is required, with another moving object keeping stopped at the target place.

4. The information processing device according to claim 1, wherein the processor arranges, in the coordinate space, one of overlapping occupied areas for which the spatiotemporal occupied areas or the temporal occupied area mutually overlap, in such a way that overlap is resolved.

5. The information processing device according to claim 4, wherein the processor arranges the one of the overlapping occupied areas, in chronological order of overlap, in the coordinate space in such a way that the other one of the overlapping occupied area does not overlap the one of the overlapping occupied area.

6. The information processing device according to claim 5, wherein the processor arranges the one of the overlapping occupied areas at a later time in the coordinate space in such a way that the other one of the overlapping occupied area does not overlap the one of the overlapping occupied areas.

7. The information processing device according to claim 1, wherein the processor arranges an occupied area for a second moving object in the coordinate space in such a way that the second moving object crosses a first moving object at a position and a time of an occupied area for the first moving object in the coordinate space.

8. The information processing device according to claim 7, wherein the processor arranges occupied areas for a plurality of the second moving objects in a leveled manner in the coordinate space in such a way that the plurality of the second moving objects crosses the first moving object at a plurality of positions and times corresponding to a plurality of occupied areas for the first moving object in the coordinate space.

9. An information processing method to be performed by a computer, comprising:
setting, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and
arranging the plurality of occupied areas in the coordinate space in such a way that the spatiotemporal occupied areas do not mutually overlap and the temporal occupied areas do not mutually overlap.

10. A non-transitory computer-readable recording medium storing a program, the program causing a computer to perform processing comprising:
setting, in a coordinate space to which a spatial axis and a temporal axis are set, a plurality of occupied areas including a spatiotemporal occupied area and a temporal occupied area, wherein the spatiotemporal occupied area indicates a space and a time occupied by movement of a moving object, wherein the temporal occupied area indicates a time occupied by a time interval of movement of the moving object; and
arranging the plurality of occupied areas in the coordinate space in such a way that the spatiotemporal occupied areas do not mutually overlap and the temporal occupied areas do not mutually overlap.
